(19) United States
(12) Patent Application Publication
(10) Pub. No.: US 2026/0222483 A1
(43) Pub. Date: Jul. 30, 2026

(54) METHOD AND APPARATUS FOR SWITCHING CONTROL OF MULTI-MODE EARPHONE

(71) Applicant: YEALINK (XIAMEN) NETWORK TECHNOLOGY CO., LTD., Xiamen (CN)

(72) Inventors: Weiping SHI, Xiamen (CN); Bingcai LIN, Xiamen (CN)

(73) Assignee: YEALINK (XIAMEN) NETWORK TECHNOLOGY CO., LTD., Xiamen (CN)

(21) Appl. No.: 19/438,448

(22) Filed: Dec. 31, 2025

Related U.S. Application Data
(63) Continuation of application No. PCT/CN2025/138758, filed on Nov. 28, 2025.

(30) Foreign Application Priority Data
Jan. 25, 2025 (CN) 202510120497.9

(51) Int. Cl. H04M 1/72412; H04M 1/72409; H04R 1/10

(52) U.S. Cl. CPC H04M 1/72412; H04M 1/724094; H04R 1/1041; H04R 1/1058; H04R 2420/07

(57) ABSTRACT

A method for switching control of a multi-mode earphone, including: acquiring call data from the multi-mode earphone; the multi-mode earphone being configured to transmit the call data through the communication module; determining a call mode of the multi-mode earphone based on the call data; the call mode including calling using both a first mode and a second mode; and controlling the first communication sub-module to be disconnected from the first antenna when the call mode is the calling using both the first mode and the second mode, so that the first communication sub-module transmits signals through the second antenna and the second communication sub-module transmits signals through the first antenna.

### CROSS-REFERENCE TO RELATED APPLICATIONS

This application is a U.S. continuation of International Application No. PCT/CN2025/138758, filed on November 28, 2025, which claims priority to and the benefit of Chinese Patent Application No. 202510120497.9, filed on January 25, 2025. The disclosures of the aforementioned applications are incorporated herein by reference in their entireties.

### TECHNICAL FIELD

This application relates to, but is not limited to, a method and apparatus for switching control of a multi-mode earphone.

### BACKGROUND

In recent years, earphone design has evolved from a single-protocol apparatus to a multi-protocol apparatus. Traditional products typically only allow users to choose between Bluetooth, Digital Enhanced Cordless Telecommunications (DECT), or USB: Bluetooth earphones are designed for short-range communication with mobile terminals, DECT earphones are only used with desktop base stations for medium- to long-range communications, and USB earphones rely on wired interfaces to connect to computers. With the rise of mobile work, hybrid meetings, and multi-apparatus concurrent scenarios, users need to switch between or use different protocols simultaneously within the same earphone to handle multitasking needs such as "PC-based DECT/USB conferencing combined with mobile phone Bluetooth calling." Therefore, the industry has begun integrating Bluetooth, DECT, and USB into a single apparatus, creating multi-mode earphones: users can use the earphone at the office to connect to a PC via a DECT base station or USB for meetings, and immediately switch to Bluetooth at home to listen to music or continue the meeting; they can also maintain a DECT/USB communication on the PC while simultaneously connecting another communication via Bluetooth on their mobile phone, quickly establishing a multi-party meeting. A single earphone can cover all audio links for the office, home, and travel, perfectly suited to today's multitasking work and lifestyle.

### SUMMARY

In some embodiments of this application provides a method for switching control of a multi-mode earphone, applicable to the multi-mode earphone including a communication module that includes: a first antenna; a second antenna; a first communication sub-module connected to the first antenna and the second antenna; and a second communication sub-module connected to the first antenna through an antenna combiner. The first communication sub-module and the second communication sub-module are of different types. The method includes: acquiring call data from the multi-mode earphone; where the multi-mode earphone is configured to transmit the call data through the communication module; determining a call mode of the multi-mode earphone based on the call data; where the call mode includes calling using both a first mode and a second mode; and controlling the first communication sub-module to be disconnected from the first antenna when the call mode is the calling using both the first mode and the second mode, so that the first communication sub-module transmits signals through the second antenna and the second communication sub-module transmits signals through the first antenna.

In some embodiments of this application provides an apparatus for switching control of a multi-mode earphone, applicable to the multi-mode earphone including a communication module that includes: a first antenna; a second antenna; a first communication sub-module connected to the first antenna and the second antenna; and a second communication sub-module connected to the first antenna through an antenna combiner. The first communication sub-module and the second communication sub-module are of different types. The apparatus includes: a data acquisition module, configured to acquire call data from the multi-mode earphone; where the multi-mode earphone is configured to transmit the call data through the communication module; a call mode module, configured to determine a call mode of the multi-mode earphone based on the call data; where the call mode includes calling using both a first mode and a second mode; and a combined control module, configured to control the first communication sub-module to be disconnected from the first antenna when the call mode is the calling using both the first mode and the second mode, so that the first communication sub-module transmits signals through the second antenna and the second communication sub-module transmits signals through the first antenna.

In some embodiments of this application provides a system for switching control of a multi-mode earphone, which includes the multi-mode earphone, a DECT base station and at least one external device. The multi-mode earphone includes a communication module and an apparatus for switching control. The communication module includes: a first antenna; a second antenna; a first communication sub-module connected to the first antenna and the second antenna; and a second communication sub-module connected to the first antenna through an antenna combiner. The first communication sub-module and the second communication sub-module are of different types. The apparatus for switching control includes: a data acquisition module, configured to acquire call data from the multi-mode earphone; where the multi-mode earphone is configured to transmit the call data through the communication module; a call mode module, configured to determine a call mode of the multi-mode earphone based on the call data; where the call mode includes calling using both a first mode and a second mode; and a combined control module, configured to control the first communication sub-module to be disconnected from the first antenna when the call mode is the calling using both the first mode and the second mode, so that the first communication sub-module transmits signals through the second antenna and the second communication sub-module transmits signals through the first antenna. The DECT base station is configured to form a first communication connection with the first communication sub-module of the multi-mode earphone. The at least one external device is configured to form a second communication connection with the second communication sub-module of the multi-mode earphone.

### BRIEF DESCRIPTION OF THE DRAWINGS

FIG. 1 is a flowchart illustrating a method for switching control of a multi-mode earphone according to an embodiment of this application.

FIG. 2 is a structural diagram of an apparatus for switching control of a multi-mode earphone according to an embodiment of this application.

FIG. 3 is a structural diagram of a multi-mode earphone according to an embodiment of this application.

FIG. 4 is a structural diagram of a communication module according to an embodiment of this application.

FIG. 5 is a structural diagram of the use of the multi-mode earphone according to an embodiment of this application.

FIG. 6 is a structural diagram of a DECT&BT dual-mode communication system according to an embodiment of this application.

FIG. 7 is a structural diagram of a terminal device according to an embodiment of this application.

FIG. 8 is a structural diagram of a call mode module according to an embodiment of this application.

### DETAILED DESCRIPTION OF THE EMBODIMENTS

The technical solutions of the embodiments of this application will be clearly and completely described below with reference to the accompanying drawings. The described embodiments are only some embodiments of this application, and not all embodiments. Based on the embodiments of this application, all other embodiments obtained by those of ordinary skill in the art without creative effort are within the scope of protection of this application.

For example, embodiments of this application can be applied to the field of communication technology.

An embodiment of this application provides a method for switching control of a multi-mode earphone, applicable to the multi-mode earphone including a communication module that includes:

a first antenna;

a second antenna;

a first communication sub-module connected to the first antenna and the second antenna;

a second communication sub-module connected to the first antenna through an antenna combiner;

wherein the first communication sub-module and the second communication sub-module are of different types;

the method includes:

acquiring call data from the multi-mode earphone; wherein the multi-mode earphone is configured to transmit the call data through the communication module;

determining a call mode of the multi-mode earphone based on the call data; wherein, the call mode includes: a calling using both a first mode and a second mode;

controlling the first communication sub-module to be disconnected from the first antenna when the call mode is determined to be the calling using both the first mode and the second mode, so that the first communication sub-module is enabled to transmit signals through the second antenna and the second communication sub-module is enabled to transmit signals through the first antenna.

Specifically, the first mode can be DECT, and the second mode can be Bluetooth; the first communication sub-module can be a DECT module, and the second communication sub-module can be a Bluetooth module.

The method for switching control of a multi-mode earphone described in this application may be executed by a central processing unit (CPU).

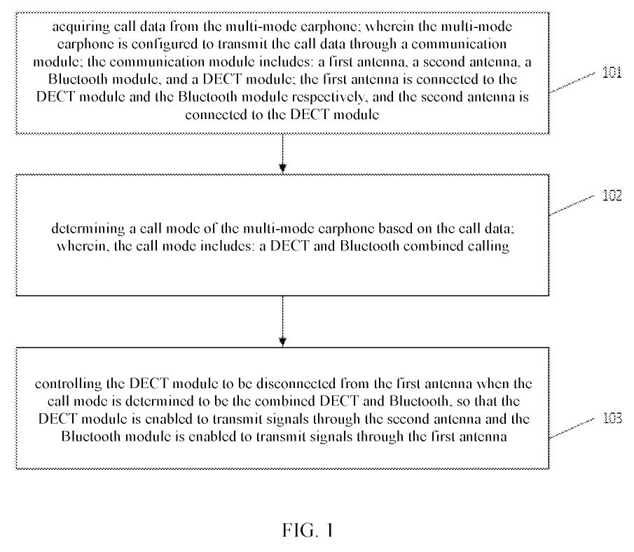

Referring to FIG. 1, which is a flowchart illustrating a method for switching control of a multi-mode earphone according to an embodiment of this application. As shown in FIG. 1, this embodiment includes operations 101 to 103 as follows:

acquiring call data from the multi-mode earphone; wherein the multi-mode earphone is configured to transmit the call data through a communication module; the communication module includes: a first antenna, a second antenna, a Bluetooth module, and a DECT module; the first antenna is connected to the DECT module and the Bluetooth module respectively, and the second antenna is connected to the DECT module;

determining a call mode of the multi-mode earphone based on the call data; wherein, the call mode includes: a DECT and Bluetooth combined calling; and

controlling the DECT module to be disconnected from the first antenna when the call mode is determined to be the combined DECT and Bluetooth, so that the DECT module is enabled to transmit signals through the second antenna and the Bluetooth module is enabled to transmit signals through the first antenna.

It is understood that call data from a multi-mode earphone can be acquired by the CPU of the earphone via the second communication sub-module (e.g., a Bluetooth module) or the first communication sub-module (e.g., a DECT module). The CPU is configured as the master control unit for the Bluetooth module and the DECT module, establishing a communication connection with both modules via an internal bus (e.g., I²C or SPI). The Bluetooth module and the DECT module can report call data to the CPU via the internal bus. Furthermore, communication transmission data is automatically generated by the Bluetooth module or the DECT module upon detecting an external communication request or audio stream, and includes protocol type, link status, and apparatus identification information. Call mode data is generated based on the user's operation of the mode switching button, used to indicate preset target call modes to users.

In this embodiment, call data is acquired from the multi-mode earphone and the current call mode is determined based on the call data; when the call mode is determined to be a combined DECT and Bluetooth, the DECT module is disconnected from the first antenna. At this time, the DECT module is enabled to transmit signals only through the second antenna, and the Bluetooth module is enabled to transmit signals only through the first antenna. This ensures that the DECT and Bluetooth modules do not share a single antenna when operating simultaneously, thus avoiding signal interference problems that occur when multiple communication modules of the multi-mode earphone use antennas simultaneously. Furthermore, in this embodiment, when the call mode of the multi-mode earphone is determined to be either DECT or Bluetooth, only one module is engaged in the communication. Therefore, by reducing the transmitting power of the module not engaged in the communication, signal interference between the two modules can be avoided.

In a possible embodiment of this application, call data is acquired from the multi-mode earphone by the CPU.

In a possible embodiment of this application, the multi-mode earphone further includes: a mode switching button; the call data includes communication transmission data and call mode data.

The determining for the call mode of the multi-mode earphone based on the call data includes:

identifying the call data;

under a condition that the call data is communication transmission data, extracting a data type information of the communication transmission data and determining the call mode of the multi-mode earphone based on the data type information; and

under a condition that the call data is call mode data, determining the call mode of the multi-mode earphones based on the call mode data; wherein, the multi-mode earphone is configured to generate call mode data in response to the user's actions on the mode switching button.

It can be understood that the call mode of a multi-mode earphone can also be determined in response to the user's actions.

It can be understood that the CPU is configured to identify the acquired call

data. If the acquired call data is communication transmission data, it means that the communication has been established. The call mode is then determined based on the type of data transmitted: if the communication transmission data is transmitted by the Bluetooth module, the call mode is Bluetooth; if the communication transmission data is transmitted by the DECT module, the call mode is DECT.

If the call data is call mode data, it means that the call mode is still being selected by the user (through selecting the call mode by pressing the mode switching button), and the call mode is determined according to the selection by the user. The call mode data includes: Bluetooth module enable data, DECT module enable data, and Bluetooth and DECT combined enable data. Specifically, Bluetooth module enable data corresponds to Bluetooth, DECT module enable data corresponds to DECT calling, and Bluetooth and DECT combined enable data corresponds to DECT and Bluetooth combined calling.

In a possible embodiment of this application, the call mode further includes DECT; the method further includes: when the call mode is DECT, reducing the transmitting power of the Bluetooth module so that the DECT module is enabled to transmit signals through the first antenna and the second antenna. It is understood that when the call mode is DECT, by adding a second antenna as the DECT antenna, this dual-antenna separation can generate a spatial filtering effect, effectively suppressing narrowband interference in complex electromagnetic environments, enhancing the transmitting power of DECT, reducing the impact of the Bluetooth module's transmitting power on DECT, and enhancing link reliability. Simultaneously, when the Bluetooth module is idle, the first antenna is released to the DECT module for use, allowing the two antennas to work together and maximizing hardware resource utilization.

For example, in one or more embodiments of this application, when the call mode is DECT, the transmitting power of the Bluetooth module can be reduced to a first power. The specific value of the first power is not limited.

In a possible embodiment of this application, the call mode further includes Bluetooth; the method further includes: when the call mode is Bluetooth, reducing the transmitting power of the DECT module and controlling the Bluetooth module to transmit signals through the first antenna. It is understood that disconnecting the DECT module from the first antenna reduces the transmitting power of the DECT module, eliminates co-channel interference, and improves Bluetooth quality.

For example, in one or more embodiments of this application, when the call mode is Bluetooth, the transmitting power of the DECT module is reduced to a second power. The specific value of the second power is not limited. For example, a fixed value can be set, and the transmitting power of the DECT module can be reduced to that fixed value. Alternatively, the adjusted power of the DECT module can be determined based on the overall power consumption of the earphone. The specific values and methods of power adjustment are merely examples.

In a possible embodiment of this application, the multi-mode earphone further includes an antenna combiner, by which the first antenna is connected to the Bluetooth module and the DECT module;

the controlling on the DECT module to be disconnected from the first antenna when the call mode is the combined DECT and Bluetooth includes:

generating an antenna disconnect signal when the call mode is determined to be the combined DECT and Bluetooth;

transmitting the antenna disconnect signal to the antenna combiner so that the antenna combiner disconnects the DECT module from the first antenna according to the antenna disconnect signal; wherein, under a condition that the antenna disconnect signal is not received by the antenna combiner, the antenna combiner maintains the connection between the DECT module and the first antenna.

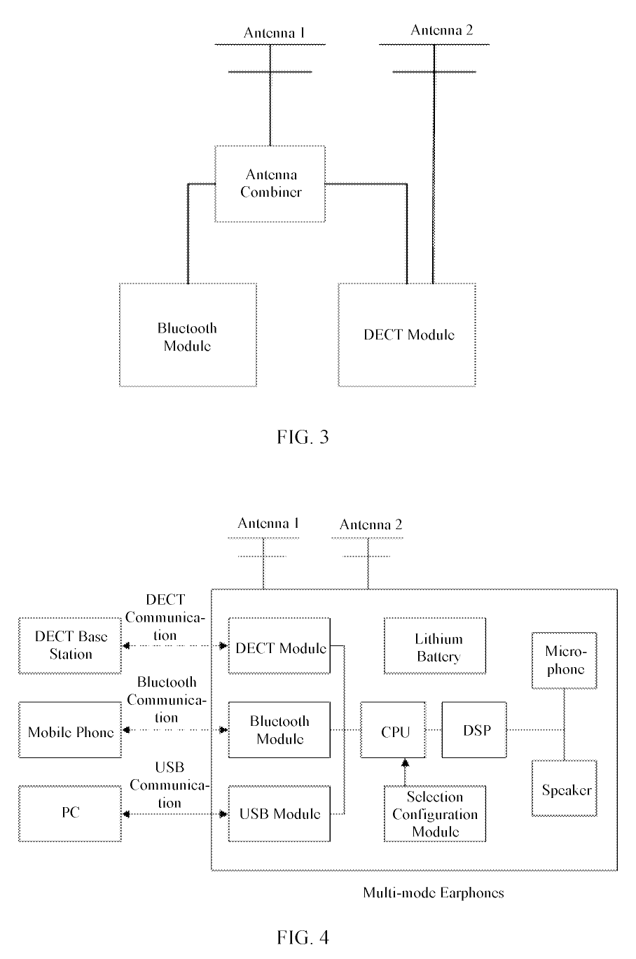

As can be understood, as shown in FIG. 3, the operating state of the multiplexed antenna is adjusted according to the connection status of the apparatus's wireless module; an antenna combiner is used in the circuit to connect the Bluetooth module and the DECT module to the same antenna; when the DECT is connected to antenna 1 and the Bluetooth is not connected to antenna 1, both antenna 1 (i.e., the first antenna described in this application) and antenna 2 (i.e., the second antenna described in this application) are used by the DECT module; when the DECT is not connected to antenna 1 and the Bluetooth is connected to antenna 1, antenna 1 is used by the Bluetooth module, and the DECT module disconnects from antenna 1 and antenna 2; antenna 1 and antenna 2 can be distributed at both ears. For example, the first antenna is disposed on the left ear housing of the multi-mode earphone, and the second antenna is disposed on the right ear housing of the multi-mode earphone. Alternatively, the second antenna is disposed on the left ear housing of the multi-mode earphone, and the first antenna is disposed on the right ear housing of the multi-mode earphone.

The use of dual antennas in DECT is because the dual-antenna design reduces interference and ensures a much wider reception range, far exceeding that of Bluetooth. Additionally, due to the earphone's small size, there isn't much space to install an antenna. To maximize DECT signal strength and range, dual antennas are needed, as there isn't enough space for a separate Bluetooth antenna. Therefore, the Bluetooth and DECT modules share a single antenna.

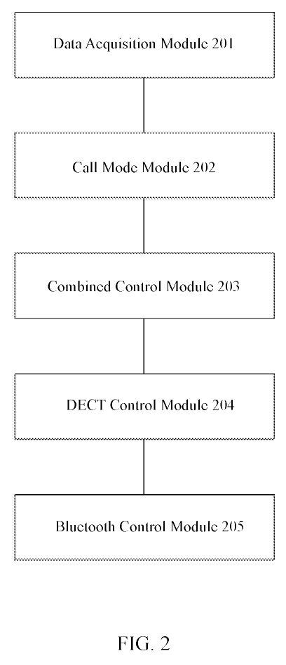

Referring to FIG. 2, which is a structural diagram of an apparatus for switching control of a multi-mode earphone according to an embodiment of this application, the apparatus includes: a data acquisition module 201, a call mode module 202, and a combined control module 203.

The data acquisition module 201 is configured to acquire call data from the multi-mode earphones; wherein, the multi-mode earphone is configured to transmit call data through the communication module; the communication module includes: a first antenna, a second antenna, a Bluetooth module, and a DECT module; the first antenna is connected to the DECT module and the Bluetooth module respectively, and the second antenna is connected to the DECT module.

The call mode module 202 is configured to determine the call mode of the multi-mode earphone based on the call data; wherein, the call mode includes: a DECT and Bluetooth combined calling.

The combined control module 203 is configured to control the DECT module to disconnect from the first antenna when the call mode is the combined DECT and Bluetooth, so that the DECT module is enabled to transmit signals through the second antenna and the Bluetooth module is enabled to transmit signals through the first antenna.

It is understood that call data from a multi-mode earphone can be acquired by the earphone's CPU via a Bluetooth module or a DECT module. The CPU is configured as the master control unit for both the Bluetooth and DECT modules, establishing a communication connection with them via an internal bus (such as I²C or SPI). The Bluetooth and DECT modules can report call data to the CPU via the internal bus. Furthermore, communication transmission data is automatically generated by the Bluetooth or DECT module upon detecting an external communication request or audio stream, and includes protocol type, link status, and apparatus identification information. Call mode data is generated based on the user's actions on the mode switching button, indicating preset target call modes to the user.

In this application, call data is acquired from the multi-mode earphone and the current call mode of the multi-mode earphone is determined based on the call data. When the call mode is determined to be the combined DECT and Bluetooth, the DECT module is disconnected from the first antenna. At this time, the DECT module is enabled to transmit signals only through the second antenna, and the Bluetooth module is enabled to transmit signals only through the first antenna. This ensures that the DECT module and the Bluetooth module do not share a single antenna when operating simultaneously, thereby avoiding signal interference problems that occur when multiple communication modules of the multi-mode earphone use antennas at the same time.

In a possible embodiment of this application, the call mode further includes DECT; the apparatus further includes: a DECT control module 204 configured to reduce the transmitting power of the Bluetooth module when the call mode is DECT, so that the DECT module is enabled to transmit signals through the first antenna and the second antenna.

In a possible embodiment of this application, the call mode further includes Bluetooth; the apparatus further includes a Bluetooth control module 205 configured to reduce the transmitting power of the DECT module when the call mode is Bluetooth, so that the Bluetooth module is enabled to transmit signals through the first antenna.

In a possible embodiment of this application, the multi-mode earphone further includes an antenna combiner, by which the first antenna is connected to the Bluetooth module and the DECT module;

the controlling of the DECT module to be disconnected from the first antenna when the call mode is determined to be the combined DECT and Bluetooth includes:

generating an antenna disconnect signal when the call mode is determined to be the combined DECT and Bluetooth;

transmitting the antenna disconnect signal to the antenna combiner so that the antenna combiner disconnects the DECT module from the first antenna according to the antenna disconnect signal; wherein, under a condition that the antenna disconnect signal is not received by the antenna combiner, the antenna combiner maintains the connection between the DECT module and the first antenna.

Referring to FIG. 8, which is a possible embodiment of this application, the multi-mode earphone further includes a mode switching button; the call data includes communication transmission data and call mode data;

the call mode module 202 includes an identification unit, a communication transmission unit, and a call mode unit.

The identification unit is configured to identify the call data.

The communication transmission unit is configured to extract the data type information of the communication transmission data and determine the call mode of the multi-mode earphone based on the data type under a condition that the call data is communication transmission data.

The call mode unit is configured to determine the call mode of the multi-mode earphone based on the call mode data under a condition that the call data is call mode data; wherein, the call mode data is generated in response to the user's actions on the mode switching button.

It is understood that call data is required from the multi-mode earphone and the current call mode is determined based on the call data; when the call mode is determined to be a combined DECT and Bluetooth, the DECT module is disconnected from the first antenna. At this time, based on the connection of the communication module of the multi-mode earphone, the DECT module is enabled to transmit signals only through the second antenna, and the Bluetooth module is enabled to transmit signals only through the first antenna. This ensures that the DECT and Bluetooth modules do not share a single antenna when operating simultaneously, thus avoiding signal interference problems that occur when multiple communication modules of the multi-mode earphone use antennas simultaneously.

Furthermore, in this embodiment of the application, when it is determined that the call mode of the multi-mode earphone is DECT or Bluetooth, only one module is used for communication at this time. Therefore, by reducing the transmitting power of the module that is not used for communication, it can be ensured that there is no signal interference between the two modules.

In a possible embodiment of this application, this embodiment also includes other structures of the multi-mode earphone. As shown in FIG. 4, it also includes: a lithium battery, a DSP chip, a microphone, a speaker, a USB module and a selection configuration module. The microphone is configured to collect user voice information; the speaker is configured to play the transmitted sound information; the lithium battery is configured to provide power to the apparatus; DSP means Digital Signal Processing technology, and a DSP chip is configured to implement digital signal processing; the DECT module is configured to connect to a DECT base station via DECT; the Bluetooth module is configured to connect to a mobile phone via Bluetooth; and a USB module is configured to connect to a computer (PC) via USB communication.

In a specific application scenario, the multi-mode earphone is implemented as a headset that includes a configuration module to receive user mode configuration commands and configure the earphone's operating modes: Mode 1 for DECT, Mode 2 for Bluetooth, Mode 3 for combined DECT and Bluetooth for establishing multi-party conferences or one-way communications while one-way communications are held, and Mode 4 for USB communication. Mode configuration commands come from earphone buttons, PC control software, mobile phone control software, or the touchscreen or buttons of the DECT base station. For example, Mode 1 is for DECT connection to a desktop unified workbench (Zoomina Base) or using a DECT dongle or DECT base station; Mode 2 is for connecting to a mobile phone via Bluetooth for Bluetooth callings; Mode 3 is for operating the multiple modes simultaneously; for example, when the combined DECT and Bluetooth is operated, with DECT taking priority, detecting DECT connection during dialing, and using DECT for dialing under a condition that a DECT connection is available. Under a condition that multi-mode simultaneous operation is supported, and a calling comes in via DECT while one Bluetooth is active, the earphone will ring to indicate the incoming DECT calling. After answering the DECT, the Bluetooth calling will be in hold mode. DECT+ Bluetooth +USB communication conference mixing can also be achieved. Additionally, the DECT or Bluetooth wireless module can be automatically turned off when it has been inactive for an extended period (10 minutes), thus improving battery life.

In a possible embodiment of this application, the multi-mode earphone further includes: a mode switching button; the call data includes communication transmission data and call mode data.

The determining for the call mode of the multi-mode earphone based on the call data includes:

identifying the call data;

under a condition that the call data is communication transmission data, extracting a data type information of the communication transmission data and determining the call mode of the multi-mode earphone based on the data type information;

under a condition that the call data is call mode data, determining the call mode of the multi-mode earphone based on the call mode data;

Specifically, when the multi-mode earphone is within the DECT communication area, call mode data corresponding to the DECT calling is generated based on the positioning of the multi-mode earphone; the positioning of the multi-mode earphone is determined based on the beacon signal received from the beacon module.

In a possible embodiment of this application, mode selection can also be achieved by using Bluetooth beacon positioning technology to identify the current location of the earphone. Based on Bluetooth, the distance between the earphone and the DECT base station is determined. When the earphone is detected entering the DECT communication area via Bluetooth, the DECT module is activated, and the earphone is switched to DECT mode or BT+DECT mode. The selection configuration module is controlled by the user or by the earphone's location. When roaming outside the DECT wireless range, the user can still use the same earphone to make/receive calls on their mobile phone.

In a possible embodiment of this application, the beacon module can be configured independently.

In a possible embodiment of this application, the beacon module can be installed on a DECT base station.

Taking a base station containing a beacon module as an example, the base station can continuously send Bluetooth signals (containing the same UUID; under a condition that there are multiple identical UUIDs in an area, other information can be attached to distinguish them) to the surrounding area. When the earphone enters the designated area, it can receive the signal, and the earphone locates, receives, and feeds back the signal. For example, based on the signal strength or identification of the beacon, the multi-mode earphone is determined to be within the DECT communication area, and the earphone can automatically generate mode configuration data to activate the DECT module accordingly.

When the DECT base station receives a feedback signal, indicating that the earphone has entered the DECT communication area, the DECT module is activated. The DECT module consumes a significant amount of power, and users turn it off when unlikely to leave the office area. Adding a beacon module to the base station or placing it in the office can help pinpoint the earphone's location.

Here, beacon positioning is used as an example only. In other embodiments, other positioning methods may be used, and there are no limitations on this.

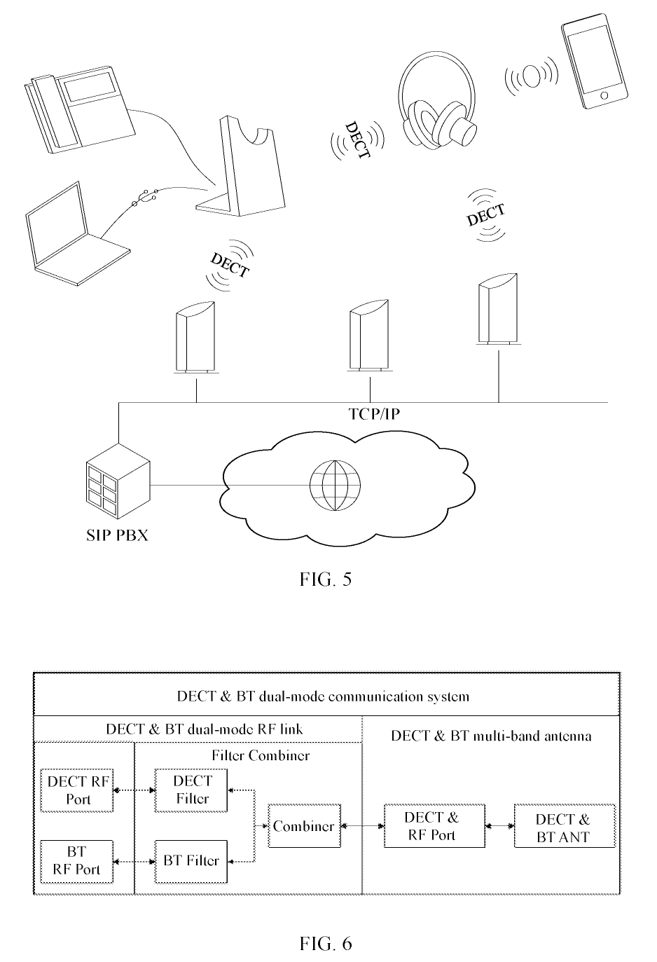

In a possible embodiment of this application, please refer to FIG. 5, which shows the product form provided in this embodiment, enabling both commercial and home use of the earphone. In an office environment, users typically have a personal computer and a wired telephone on their desks. The earphone dock is a DECT base station coupled to the personal computer or telephone. The earphone dock includes a wireless transceiver using the DECT protocol. The earphone dock's wireless transceiver has a wireless communication range and is in communication with the associated earphone. Meeting rooms and break rooms within the office area are within the wireless communication range, while the parking lot is outside. When a user leaves the company with the earphone, such as arriving at the parking lot, the DECT connection will automatically turn off after a long period of inactivity. When the user returns to the company, the beacon module recognizes the Bluetooth device returning to the area and will activate the DECT module for reconnection. The Bluetooth earphone or DECT earphone goes into sleep mode after disconnection, not shut down; thus, the Bluetooth earphone will automatically reconnect when it returns to a place within the range.

To better explain, DECT (Digital Enhanced Cordless Telecommunications) is an enhanced digital cordless telephone standard developed by the European Telecommunications Standards Institute (ETSI). It is an open, evolving digital communication standard primarily used in cordless telephone systems. It provides a framework for cordless communication, offering high-quality voice and data services for high-user-density, short-range communication. USB (Universal Serial Bus) is a serial bus standard and an input/output interface specification widely used in personal computers and mobile devices, and extending to photographic equipment, digital televisions (set-top boxes), game consoles, and other related fields. Multi-mode (DECT+BT+USB) configurations are configurable by the factory. For example, if the DECT frequency band is not supported in China, the factory can disable the DECT baseband by writing different configuration files (with same earphone software, different configuration files) using dedicated software, supporting only Bluetooth and USB modes to comply with local laws and regulations.

It can be understood that, the user's experience using the multi-mode earphone includes: 1. Using PC control software to turn Bluetooth, USB, and DECT on/off to improve battery life; 2. Users can also turn the modules on/off using the mode switch button; 3. The wireless module automatically shuts down after a long period of inactivity to improve battery life.

Charging methods for multi-mode earphone include: 1. Charging via USB; 2. Charging by placing the earphone on a DECT base station and connecting via contacts.

Firmware upgrades for multi-mode earphone include: 1. Upgrading the earphone firmware using PC control software. For example, Yealink USB Connect software, developed by Yealink, is used for device management and software upgrades; 2. Upgrading the earphone software by placing the earphone on a DECT base station and connecting via contacts. This embodiment enables switching between different modes for multi-mode earphone, making them suitable for various scenarios.

Referring to FIG. 6, in a possible embodiment of this application, a DECT & BT dual-mode earphone is disclosed, which consists of two parts: a "DECT & BT dual-mode radio frequency link" and a "DECT & BT multi-frequency antenna".

The first part is the DECT & BT dual-mode RF link, which consists of a BT chip, a DECT chip, and a filter combiner. The BT chip internally includes a Bluetooth module, an RF transceiver, a processor, and memory, ensuring normal BT wireless communication. The DECT chip internally includes a DECT module, an RF transceiver, a processor, and memory, enabling normal DECT wireless communication. The filter combiner consists of a filter and a combiner. The filter significantly attenuates signals outside the main frequency to an acceptable noise floor (the DECT filter significantly attenuates RF signals outside the DECT main frequency, resulting in an RF signal within the acceptable noise floor range for BT; the BT filter significantly attenuates RF signals outside the BT main frequency, resulting in an RF signal within the acceptable noise floor range for DECT). The combiner then combines the DECT and BT signals into a single signal, effectively isolating the two frequency bands. The second part is the DECT & BT multi-band antenna, which is an antenna that meets the bandwidth performance requirements of the DECT band (1.88G~1.93G, 1.78G~1.8G) and the BT band (2.4G~2.48G).

The DECT&BT dual-mode communication earphone has the following three wireless communication states, none of which interfere with each other.

The first state is as follows: when DECT is in operation, DECT conducts normal wireless communication through the path from DECT RF Port through DECT filter, the combiner to DECT & BT ANT (antenna). At the same time, the DECT signal branch is attenuated to the noise floor range by the BT filter in the filter combiner, which will not affect the transmission and reception of BT.

The second state is as follows: when BT is in operation, BT conducts normal wireless communication through the path from BT RF Port to DECT filter through the combiner to DECT & BT ANT. At the same time, the BT signal branch is attenuated to the noise floor range by the DECT filter in the filter combiner, which will not affect the transmission and reception of DECT.

The third state is that DECT and BT operate simultaneously without interfering with each other. Since DECT communicates normally via the path from DECT RF Port through DECT filter, the combiner to DECT & BT ANT, and the DECT signal branch is attenuated to the noise floor level by the BT filter in the filter combiner, it does not affect BT's transmission and reception. Similarly, when BT (Bluetooth) is operating, it communicates normally via the path from BT RF Port through DECT filter, the combiner to DECT & BT ANT, and the BT signal branch is attenuated to the noise floor level by the DECT filter in the filter combiner, it does not affect DECT's transmission and reception.

This embodiment introduces a design of DECT&BT dual-mode communication, where DECT and BT can share a radio frequency link and antenna. This ensures that when they work simultaneously, the wireless parameters are normal, and music playback and voice communications are normal, without any abnormal issues such as stuttering, packet loss, or electronic noise.

Another possible embodiment of this application also provides a system for switching control of a multi-mode earphone, including:

a multi-mode earphone; the specific structure, functions and execution methods of the multi-mode earphone can be referred to other contents of this document, and will not be repeated here;

a DECT base station, configured to establish a DECT connection to the DECT module of the multi-mode earphone; the details of the DECT base station can be found in other parts of this document and will not be repeated here;

at least an external equipment, configured to establish a Bluetooth connection with the Bluetooth module of the multi-mode earphone. For example, the external equipment can be a mobile phone, tablet, etc. Detailed descriptions can be found elsewhere in this document and will not be repeated here.

Embodiments of this application also provide a communication module for multi-mode earphone, including:

a first communication sub-module connected to a first antenna and a second antenna;

a second communication sub-module connected to the first antenna via an antenna combiner;

wherein the first communication sub-module and the second communication sub-module are of different types.

Optionally, the first communication sub-module is a DECT module, and/or the second communication sub-module is a Bluetooth module. The types of the first communication sub-module (DECT) and the second communication sub-module (Bluetooth) are merely examples; other types are possible in other examples. Anything that meets the form factor and multitasking requirements of a multi-mode earphone is acceptable. For example, the first and second communication sub-modules can also employ various wireless transmission methods such as Wi-Fi and 2.4G to meet the multitasking needs of the multi-mode earphone.

Optionally, the DECT module includes a DECT filter, and the Bluetooth module includes a BT filter.

Optionally, the first communication sub-module is connected to the first antenna through the antenna combiner.

Optionally, the first antenna is disposed on the a left ear housing of the multi-mode earphone, and the second antenna is disposed on a right ear housing of the multi-mode earphone; or, the second antenna is disposed on a left ear housing of the multi-mode earphone, and the first antenna is disposed on a right ear housing of the multi-mode earphone.

For details on the implementation and beneficial effects of this apparatus, please refer to other parts of this specification; further details will not be provided here.

This application also provides a method for switching control of a multi-mode earphone, applicable to any of the apparatuses described herein, including:

acquiring call data from the multi-mode earphone;

determining a call mode of the multi-mode earphone based on the call data; wherein, the call mode includes a calling using both a first mode and a second mode;

controlling the first communication sub-module to be disconnected from the first antenna when the call mode is determined to be the calling using both the first mode and the second mode, so that the first communication sub-module is enabled to transmit signals through the second antenna and the second communication sub-module is enabled to transmit signals through the first antenna.

Optionally, the first mode is DECT, and the second mode is Bluetooth; the first communication sub-module is a DECT module, and the second communication sub-module is a Bluetooth module.

Optionally, the call mode further includes a DECT; the method further includes: when the call mode is DECT, reducing the transmitting power of the Bluetooth module to a first power, and controlling the DECT module to transmit signals through the first antenna and the second antenna.

Optionally, the call mode further includes Bluetooth; the method further includes: when the call mode is Bluetooth, reducing the transmitting power of the DECT module to a second power, and controlling the Bluetooth module to transmit signals through the first antenna.

Optionally, the multi-mode earphone further includes an antenna combiner; wherein the first antenna is connected to the Bluetooth module and the DECT module by the antenna combiner;

the controlling on the first communication sub-module to be disconnected from the first antenna when the call mode is determined to be the combined DECT and Bluetooth includes:

generating an antenna disconnect signal is generated when the call mode is determined to be the combined DECT and Bluetooth;

transmitting the antenna disconnect signal to the antenna combiner so that the antenna combiner disconnects the DECT module from the first antenna according to the antenna disconnect signal; wherein, under a condition that the antenna disconnect signal is not received by the antenna combiner, the antenna combiner maintains the connection between the DECT module and the first antenna.

Optionally, the multi-mode earphone further includes a mode switching button; the call data includes communication transmission data and call mode data;

the determining of the call mode of the multi-mode earphone based on the call data includes:

identifying the call data;

under a condition that the call data is communication transmission data, extracting data type information of the communication transmission data and determining the call mode of the multi-mode earphone based on the data type information;

under a condition that the call data is call mode data, determining the call mode of the multi-mode earphone based on the call mode data;

wherein, the multi-mode earphone is configured to generate call mode data in response to the user's actions on the mode switching button.

Optionally, the multi-mode earphone further includes a mode switching button; the call data includes communication transmission data and call mode data;

the determining of the call mode of the multi-mode earphone based on the call data includes:

identifying the call data;

under a condition that the call data is communication transmission data, extracting data type information of the communication transmission data and determining the call mode of the multi-mode earphone based on the data type information;

under a condition that the call data is call mode data, determining the call mode of the multi-mode earphone based on the call mode data;

Specifically, when the multi-mode earphone is within the DECT communication area, call mode data corresponding to the DECT calling is generated based on the positioning of the multi-mode earphone; the positioning of the multi-mode earphone is determined based on the beacon signal received from the beacon module.

For details on the specific implementation and beneficial effects of this method, please refer to other parts of this specification; further details will not be provided here.

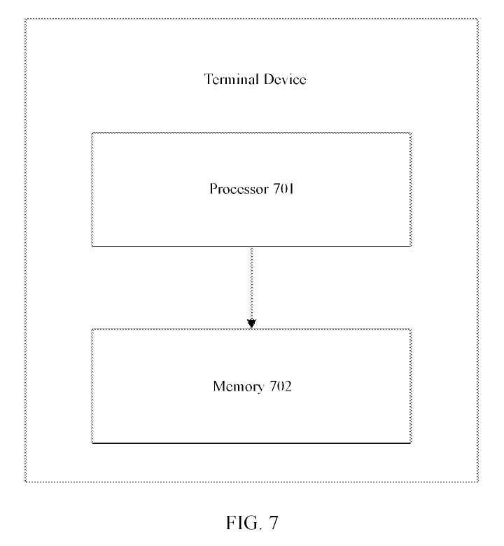

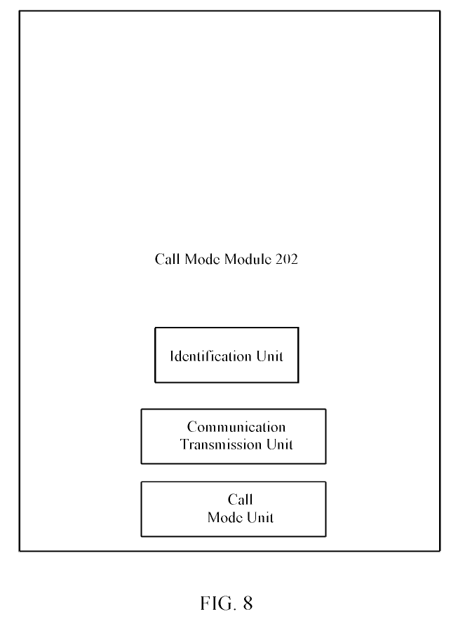

Please refer to FIG. 7, which is a structural diagram of a terminal device according to an embodiment of this application.

The terminal device according to this embodiment includes: a processor 701, a memory 702, and computer programs stored in the memory 702 and executable on the processor 701. When the processor 701 executes the computer programs, the various method for switching control of a multi-mode earphone described above in the embodiments are implemented, such as including all the operations of method for switching control of a multi-mode earphone shown in FIG. 1. Alternatively, when the processor executes the computer programs, the functions of each module in the various apparatus embodiments described above are implemented, such as all modules of the apparatus for switching control of a multi-mode earphone shown in FIG. 2.

A possible embodiment of this application provides a computer-readable storage medium including computer programs stored thereon, wherein, when the computer programs are executed, the apparatus where the computer-readable storage medium is located to perform the method for switching control of a multi-mode earphone as described in any of the above embodiments.

Those skilled in the art will understand that the schematic diagram is merely an example of a terminal device and does not constitute a limitation on the terminal device. It may include more or fewer components than shown in the diagram, or combine certain components, or different components. For example, the terminal device may also include input/output devices, network access devices, buses, etc.

The processor 701 may be a Central Processing Unit (CPU), or other general-purpose processors, digital signal processors (DSPs), application-specific integrated circuits (ASICs), field-programmable gate arrays (FPGAs), or other programmable logic devices, discrete gate or transistor logic devices, discrete hardware components, etc. The general-purpose processor may be a microprocessor or any conventional processor. The processor 701 is the control center of the terminal device, connecting various parts of the terminal device through various interfaces and lines.

The memory 702 can be used to store the computer programs and/or modules. The processor 701 implements various functions of the terminal device by running or executing the computer programs and/or modules stored in the memory and calling the data stored in the memory 702. The memory 702 may mainly include a program storage area and a data storage area. The program storage area may store the operating system, at least one application program required for a function (such as sound playback function, image playback function, etc.), etc.; the data storage area may store data created according to the use of the mobile phone (such as audio data, phonebook, etc.). In addition, the memory may include high-speed random access memory, and may also include non-volatile memory, such as hard disk, memory, plug-in hard disk, smart media card (SMC), secure digital (SD) card, flash card, at least one disk storage device, flash memory device, or other volatile solid-state storage device.

If the modules/units integrated in the terminal device are implemented as software functional units and sold or used as independent products, they can be stored in a computer-readable storage medium. Based on this understanding, all or part of the processes in the methods of the above embodiments of this application can also be implemented by a computer program instructing related hardware. The computer program can be stored in a computer-readable storage medium, and when the computer program is executed by a processor, it can implement the operations of the various method embodiments described above. The computer program includes computer program codes, which can be in the form of source codes, object codes, executable file, or some intermediate form, etc. The computer-readable medium can include: any entity or device capable of carrying the computer program codes, recording medium, USB flash drive, portable hard drive, magnetic disk, optical disk, computer memory, read-only memory (ROM), random access memory (RAM), electrical carrier signal, telecommunication signal, and software distribution medium, etc.

It should be noted that the device embodiments described above are merely illustrative. The units described as separate components may or may not be physically separate, and the components shown as units may or may not be physical units; that is, they may be located in one place or distributed across multiple network units. Some or all of the modules can be selected to achieve the purpose of this embodiment according to actual needs. Furthermore, in the accompanying drawings of the device embodiments provided in this application, the connection relationships between modules indicate that they have communication connections, which can be specifically implemented as one or more communication buses or signal lines. Those skilled in the art can understand and implement this without any creative effort.

The above description is the preferred embodiments of this application. It should be noted that for those skilled in the art, several improvements and modifications can be made without departing from the principle of this application, and these improvements and modifications are also considered to be within the scope of protection of this application.

What is claimed is:

1. A method for switching control of a multi-mode earphone, applicable to the multi-mode earphone comprising a communication module that comprises:
a first antenna;
a second antenna;
a first communication sub-module connected to the first antenna and the second antenna; and
a second communication sub-module connected to the first antenna through an antenna combiner;
wherein the first communication sub-module and the second communication sub-module are of different types;
wherein the method comprises:
acquiring call data from the multi-mode earphone; wherein the multi-mode earphone is configured to transmit the call data through the communication module;
determining a call mode of the multi-mode earphone based on the call data; wherein the call mode comprises calling using both a first mode and a second mode; and
controlling the first communication sub-module to be disconnected from the first antenna when the call mode is the calling using both the first mode and the second mode, so that the first communication sub-module transmits signals through the second antenna and the second communication sub-module transmits signals through the first antenna.

2. The method for switching control of a multi-mode earphone of claim 1, wherein the first mode is a Digital Enhanced Cordless Telecommunications (DECT), and the second mode is Bluetooth; the first communication sub-module is a DECT module, and the second communication sub-module is a Bluetooth module.

3. The method for switching control of a multi-mode earphone of claim 1, wherein the call mode further comprises calling using the first mode;
wherein the method further comprises: when the call mode is the calling using the first mode, reducing a transmitting power of the second communication sub-module to a first power, and controlling the first communication sub-module to transmit signals through the first antenna and the second antenna.

4. The method for switching control of a multi-mode earphone of claim 1, wherein the call mode further comprises calling using the second mode;
wherein the method further comprises: when the call mode is the calling using the second mode, reducing a transmitting power of the first communication sub-module to a second power, and controlling the second communication sub-module to transmit signals through the first antenna.

5. The method for switching control of a multi-mode earphone of claim 1, wherein the multi-mode earphone further comprises the antenna combiner, wherein the first antenna is connected to the second communication sub-module and the first communication sub-module through the antenna combiner;
the controlling of the first communication sub-module to be disconnected from the first antenna when the call mode is the calling using both the first mode and the second mode comprises:
generating an antenna disconnect signal when the call mode is the calling using both the first mode and the second mode; and
transmitting the antenna disconnect signal to the antenna combiner so that the antenna combiner disconnects the first communication sub-module from the first antenna based on the antenna disconnect signal; wherein, under a condition that the antenna disconnect signal is not received by the antenna combiner, the antenna combiner maintains a connection between the first communication sub-module and the first antenna.

6. The method for switching control of a multi-mode earphone of claim 1, wherein the multi-mode earphone further comprises a mode switching button; the call data comprises communication transmission data and call mode data;
wherein the determining of the call mode of the multi-mode earphone based on the call data comprises:
identifying the call data;
under a condition that the call data is communication transmission data, extracting a data type information of the communication transmission data and determining the call mode of the multi-mode earphone based on the data type information; and
under a condition that the call data is call mode data, determining the call mode of the multi-mode earphones based on the call mode data;
wherein the call mode data is generated in response to an operation on the mode switching button.

7. The method for switching control of a multi-mode earphone of claim 2, wherein the call data comprises communication transmission data and call mode data;
wherein the determining of the call mode of the multi-mode earphone based on the call data comprises:
identifying the call data;
under a condition that the call data is communication transmission data, extracting a data type information of the communication transmission data and determining the call mode of the multi-mode earphone based on the data type information; and
under a condition that the call data is call mode data, determining the call mode of the multi-mode earphone based on the call mode data;
wherein when the multi-mode earphone is within a DECT communication area, the call mode data corresponding to DECT calling is generated based on positioning of the multi-mode earphone; the positioning of the multi-mode earphone is determined based on a beacon signal received from a beacon module.

8. An apparatus for switching control of a multi-mode earphone, applicable to the multi-mode earphone comprising a communication module that comprises:
a first antenna;
a second antenna;
a first communication sub-module connected to the first antenna and the second antenna; and
a second communication sub-module connected to the first antenna through an antenna combiner;
wherein the first communication sub-module and the second communication sub-module are of different types;
wherein the apparatus comprises:
a data acquisition module, configured to acquire call data from the multi-mode earphone; wherein the multi-mode earphone is configured to transmit the call data through the communication module;
a call mode module, configured to determine a call mode of the multi-mode earphone based on the call data; wherein the call mode comprises calling using both a first mode and a second mode; and
a combined control module, configured to control the first communication sub-module to be disconnected from the first antenna when the call mode is the calling using both the first mode and the second mode, so that the first communication sub-module transmits signals through the second antenna and the second communication sub-module transmits signals through the first antenna.

9. The apparatus for switching control of a multi-mode earphone of claim 8, wherein the first mode is a Digital Enhanced Cordless Telecommunications (DECT), and the second mode is Bluetooth; the first communication sub-module is a DECT module, and the second communication sub-module is a Bluetooth module.

10. The apparatus for switching control of a multi-mode earphone claim 8, wherein the call mode further comprises calling using the first mode;
wherein the apparatus further comprises a first mode control module configured, when the call mode is the calling using the first mode, to reduce a transmitting power of the second communication sub-module to a first power, and control the first communication sub-module to transmit signals through the first antenna and the second antenna.

11. The apparatus for switching control of a multi-mode earphone claim 8, wherein the call mode further comprises calling using the second mode;
wherein the apparatus further comprises a second mode control module configured, when the call mode is the calling using the second mode, to reduce a transmitting power of the first communication sub-module to a second power, and control the second communication sub-module to transmit signals through the first antenna.

12. The apparatus for switching control of a multi-mode earphone claim 8, wherein the multi-mode earphone further comprises the antenna combiner, wherein the first antenna is connected to the second communication sub-module and the first communication sub-module through the antenna combiner;
the controlling by the combined control module of the first communication sub-module to be disconnected from the first antenna when the call mode is the calling using both the first mode and the second mode comprises:
generating an antenna disconnect signal when the call mode is the calling using both the first mode and the second mode; and
transmitting the antenna disconnect signal to the antenna combiner so that the antenna combiner disconnects the first communication sub-module from the first antenna based on the antenna disconnect signal; wherein, under a condition that the antenna disconnect signal is not received by the antenna combiner, the antenna combiner maintains a connection between the first communication sub-module and the first antenna.

13. The apparatus for switching control of a multi-mode earphone claim 8, wherein the multi-mode earphone further comprises a mode switching button; the call data comprises communication transmission data and call mode data;
wherein the call mode module comprises:
an identification unit, configured to identify the call data;
a communication transmission unit, configured to extract a data type information of the communication transmission data and determine the call mode of the multi-mode earphone based on the data type information under a condition that the call data is communication transmission data; and
a call mode unit, configure to determine the call mode of the multi-mode earphones based on the call mode data under a condition that the call data is call mode data;
wherein the call mode data is generated in response to an operation on the mode switching button.

14. The apparatus for switching control of a multi-mode earphone claim 9, wherein the call data comprises communication transmission data and call mode data;
wherein the determining of the call mode of the multi-mode earphone based on the call data comprises:
identifying the call data;
under a condition that the call data is communication transmission data, extracting a data type information of the communication transmission data and determining the call mode of the multi-mode earphone based on the data type information; and
under a condition that the call data is call mode data, determining the call mode of the multi-mode earphone based on the call mode data;
wherein when the multi-mode earphone is within a DECT communication area, the call mode data corresponding to DECT calling is generated based on positioning of the multi-mode earphone; the positioning of the multi-mode earphone is determined based on a beacon signal received from a beacon module.

15. The apparatus for switching control of a multi-mode earphone claim 8, wherein
the first antenna is disposed on a left ear housing of the multi-mode earphone, and the second antenna is disposed on a right ear housing of the multi-mode earphone; or
the second antenna is disposed on the left ear housing of the multi-mode earphone, and the first antenna is disposed on a right ear housing of the multi-mode earphone.

16. A system for switching control of a multi-mode earphone, comprising:
the multi-mode earphone, comprising:
a communication module that comprises:
a first antenna;
a second antenna;
a first communication sub-module connected to the first antenna and the second antenna; and
a second communication sub-module connected to the first antenna through an antenna combiner;
wherein the first communication sub-module and the second communication sub-module are of different types;
an apparatus for switching control, comprises:
a data acquisition module, configured to acquire call data from the multi-mode earphone; wherein the multi-mode earphone is configured to transmit the call data through the communication module;
a call mode module, configured to determine a call mode of the multi-mode earphone based on the call data; wherein the call mode comprises calling using both a first mode and a second mode; and
a combined control module, configured to control the first communication sub-module to be disconnected from the first antenna when the call mode is the calling using both the first mode and the second mode, so that the first communication sub-module transmits signals through the second antenna and the second communication sub-module transmits signals through the first antenna;
a DECT base station, configured to form a first communication connection with the first communication sub-module of the multi-mode earphone; and
at least one external device, configured to form a second communication connection with the second communication sub-module of the multi-mode earphone.

17. The system for switching control of a multi-mode earphone of claim 16, wherein the first mode is DECT, and the second mode is Bluetooth; the first communication sub-module is a DECT module, and the second communication sub-module is a Bluetooth module; the first communication connection is a DECT connection, and the second communication connection is a Bluetooth connection.

18. The system for switching control of a multi-mode earphone of claim 16, wherein the call mode further comprises calling using the first mode;
wherein the apparatus further comprises a first mode control module configured, when the call mode is the calling using the first mode, to reduce a transmitting power of the second communication sub-module to a first power, and control the first communication sub-module to transmit signals through the first antenna and the second antenna.

19. The system for switching control of a multi-mode earphone of claim 16, wherein the call mode further comprises calling using the second mode;
wherein the apparatus further comprises a second mode control module configured, when the call mode is the calling using the second mode, to reduce a transmitting power of the first communication sub-module to a second power, and control the second communication sub-module to transmit signals through the first antenna.

20. The system for switching control of a multi-mode earphone of claim 16, wherein the multi-mode earphone further comprises the antenna combiner, wherein the first antenna is connected to the second communication sub-module and the first communication sub-module through the antenna combiner;
the controlling by the combined control module of the first communication sub-module to be disconnected from the first antenna when the call mode is the calling using both the first mode and the second mode comprises:
generating an antenna disconnect signal when the call mode is the calling using both the first mode and the second mode; and
transmitting the antenna disconnect signal to the antenna combiner so that the antenna combiner disconnects the first communication sub-module from the first antenna based on the antenna disconnect signal; wherein, under a condition that the antenna disconnect signal is not received by the antenna combiner, the antenna combiner maintains a connection between the first communication sub-module and the first antenna.
